(19) United States
(12) Patent Application Publication
(10) Pub. No.: US 2013/0157617 A1
(43) Pub. Date: Jun. 20, 2013

(54) CELLULAR NETWORK INTERFACE FOR MULTI-FUNCTION DEVICES

(71) Applicants: NISCHAL MURTHY PIRATLA, HYDERABAD (IN); PRATYUSH PRASANNA, BHUBANESWAR (IN)

(72) Inventors: NISCHAL MURTHY PIRATLA, HYDERABAD (IN); PRATYUSH PRASANNA, BHUBANESWAR (IN)

(73) Assignee: XEROX CORPORATION, NORWALK, CT (US)

(21) Appl. No.: 13/329,348

(22) Filed: Dec. 19, 2011

(51) Int. Cl. H04W 12/06

(52) U.S. Cl. 455/411

(57) ABSTRACT

The present disclosure provides a method and a system for connecting a computing device to a multi-function device (MFD) associated with a cellular identification code and an address. A computing device sends a connection request including an access code over a cellular network to access a MFD. The connection request is processed to identify the MFD. Processing includes, comparing the access code with a pre-populated list of cellular identification codes for validation, and determining the IP address corresponding to the validated access code. On determining the IP address of the identified MFD, a cellular data connection is set up between the computing device and the MFD.

### TECHNICAL FIELD

The presently disclosed embodiments relate to multi-function devices, and more particularly to multi-function devices in a network.

### BACKGROUND

A multi-function device (MFD) incorporates into a single device a number of traditionally separate functionalities, such as printing, copying, scanning, and faxing. To make this functionality available to multiple users, an MFD is often incorporated in a computing network, allowing users to communicate directly with the device.

Generally, management of MFDs in a computing network requires networking knowledge (i.e., hostname, device name, IP addresses, etc), which makes locating an MFD a difficult task. Every time a user has to configure an MFD in a network, the user must know the MFD's IP address or host name. It is cumbersome for a user to keep track of the IP addresses to connect to an MFD.

Further, an administrator has to configure the MFD for every new computer added to the network, increasing configuration complexity. Moreover, with various access rights and user profiles, maintaining authorization and access records for multiple users in the computer network environment becomes cumbersome.

Managing MFDs in a network becomes a complex task when devices are frequently moved among locations. Multiple locations increase the burden of reconfiguration, as well as maintenance of extensive firewall settings required. Thus, MFDs encounter problems when mobility and wireless capabilities are desired. Currently, network devices, at both user and network levels, conventionally include an Ethernet interface, such as a network interface (NIC) card. Alternatively, networks also offer Bluetooth connectivity. Where MFDs are employed in such networks, users must be aware of the MFD's IP address, and MFD reconfiguration is still necessary on moving the MFD.

Thus, the art would benefit if a solution would provide users a convenient and manageable way to connect to mobile MFDs.

### SUMMARY

The present disclosure provides a method for connecting a computing device to a multi-function device (MFD). The method involves receiving a connection request including an access code. The method further includes validating the access code by comparing the access code with a cellular identification code. The validating step is followed by determining an address associated with the MFD. Moreover, the method involves setting up a cellular data connection between the computing device and the MFD. validating the access code, including comparing the access code with a cellular identification code

One embodiment of the present disclosure provides a system for connecting a computing device to an MFD. The system employs a cellular interface, having an associated cellular identification code. The system further includes a discovery module deployed at the computing device. The discovery module generates a connection request including an access code to access the MFD. The system employs a processing module to compare the access code with the cellular identification codes of one or more MFDs. In addition, the processing module identifies an address associated with the requested MFD using the access code. Moreover, the system employs a connection module to offer a cellular data connection between the computing device and the requested MFD based on the determined address.

Another embodiment of the present disclosure provides a multi-function device (MFD) configured to communicate on a cellular network, providing multiple imaging requests. The MFD employs a cellular interface having an associated cellular identification code. Further, the MFD is coupled to a connection module. The connection module receives a connection request including an access code and compares this code with the cellular identification code. In addition, the connection module determines an address associated with the MFD using the access code. Moreover, the connection module provides a cellular data connection with the MFD.

### BRIEF DESCRIPTION OF THE DRAWINGS

FIG. 1 schematically illustrates an exemplary system for communicating with an MFD over a cellular network, through a cellular interface configured on the MFD.

FIG. 2 illustrates a personal computer in a cellular network, configured according to an embodiment of the present disclosure.

FIG. 3 illustrates a Smartphone in a cellular network, configured according to an embodiment of the present disclosure.

### DETAILED DESCRIPTION

The following detailed description is made with reference to the figures. Preferred embodiments are described to illustrate the disclosure, not to limit its scope, which is defined by the claims. Those of ordinary skill in the art will recognize a number of equivalent variations in the description that follows.

The following terms are used throughout this document and are defined here for clarity and convenience.

“MFD” includes a single device that offers a number of traditionally separate functionalities, such as printing, copying, scanning, and faxing.

Further, “mobile device” refers to any device that has a wireless connection with a network or components related to the network. The present disclosure includes mobile devices such as laptop computers, Smartphones, PDAs, and so on.

The term “cellular identification code” refers to a unique sequence of numeric or alphanumeric characters assigned to a cellular device by the cellular provider. A device having a cellular interface is identified using this cellular identification code. For example, a mobile device connected to a GSM network may be identified by a 10-digit cellular identification code.

“Access code” may be a code that a user sends to connect to an MFD. This may be a sequence of alphanumeric characters, which may correspond to a cellular identification code.

“Telephone number” is a unique sequence of digits used to connect to a cellular device for voice, or data communication. This number may vary based on the cellular network connected to the device.

“Address” refers to generally refers to any identification means that indicates the physical location of a device in a computer network. For example, the address may be an Internet Protocol address or a universe resource locator.

### Overview

Embodiments of the present disclosure describe a cellular-interfaced multi-function device (MFD). Cellular connectivity allows the MFD to be mobile, so that it may be relocated anywhere without the need for extensive reconfiguration. Moreover, because the MFD includes cellular connectivity, users may connect to it without first connecting to a network server. For example, users may print images from their cellular phones onto an MFD in a coffee shop without having to connect to an intranet or LAN. Additionally, users do not have to remember complicated IP addresses of host names. The MFD may simply be associated with a telephone number.

A computing device, such as a desktop, laptop, or cell phone, requests access to an MFD using the telephone number associated with the MFD. A cellular network together with a printer network server finds the requested MFD and determines an IP address associated with the MFD. Using the telephone number and the associated IP address, the cellular operator may setup a data communication path between the printer and the requesting device to facilitate data transfer.

### Exemplary System

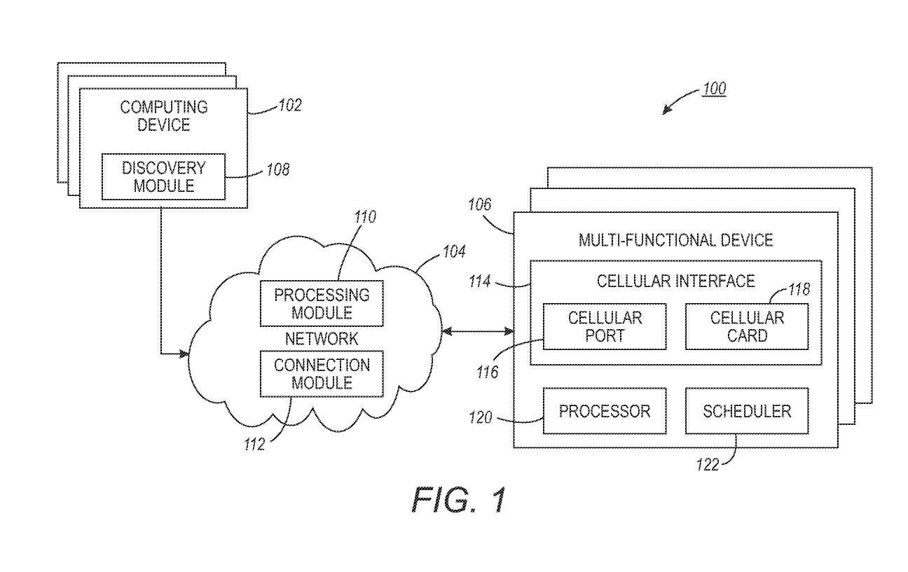

FIG. 1 schematically illustrates an exemplary system 100 in which users can easily communicate with multi-function devices. For purposes of analyzing the present disclosure, the system 100 can be visualized as having three primary components, a series of computing devices 102, a network 104, and one or more MFD's 106. In general, computing devices 102 communicate with network 104 using conventional network protocols and network 104 forwards that communication to MFD 106 over a cellular connection.

Computing device 102 can be any conventional electronic device such as a desktop computer, a laptop, or mobile device, used to communicate via network 104. As shown, computing device 102 is linked to network 104 via a conventional connection, which could be wired or wireless, as desired. Such wired or wireless connection means include wired or wireless gateways, routers, switches, hubs, or cellular base stations.

Network 104 generally refers to a collection of interconnected devices that facilitate communication and sharing of resources and information among the interconnected devices. Further, the network 104 may include all, or a portions of a local area network (LAN), a metropolitan area network (MAN), a wide area network (WAN), or a cellular network. Additionally, the network can be a local, regional, or global communication network such as an enterprise intranet, the Internet, or any combination of similar systems. For example, the network may be an interconnection between an enterprise network, the internet, and a cellular network. When the network is a combination of an enterprise network (or the Internet), and a cellular network, suitable means are employed to seamlessly communicate between the two networks. For instance, a mobile switching gateway may communicate with a computer network gateway to pass data between the two networks. Similarly, if the network 104 includes two or more networks employing differing protocols, suitable interfaces may be introduced to allow communication between these disparate networks.

MFD 106 is a device that performs printing, scanning, copying, or other known functions. It will be understood that the MFD may perform one, few, or all of the mentioned operations without departing from the scope of the present invention. For example, the MFD may be a standalone printer or facsimile machine. Alternatively, the MFD may be a three-in-one printer, scanner, and copier. Further, the MFD may include a suitable interface allowing it to connect with the network 104 and the computing devices 102. These interfaces include cellular interface, network interface, or parallel to serial interface.

These primary system components further include one or more modules that help implement embodiments of the present disclosure. These modules include discovery module 108, processing module 110, connection module 112, and cellular interface 114. The discovery module 108 may be part of the computing devices 102, the processing and connection modules 110, 112 may be part of the network 104, and the cellular interface 114 may be incorporated in the MFD 106. The following sections describe these elements in detail.

The discovery module 108, coupled with the computing device 102, allows users present on computing devices 102 to send service or connection requests to the MFD 106. This module may be similar to a conventional “add printer” routine that allows users to configure an MFD to the computing system. Unlike conventional routines, however, the discovery module 108 allows users to locate and connect to an MFD simply by using an access code, such as a telephone number, associated with the MFD. To enable user interaction, the discovery module 108 may include a graphical user interface. Based on the user input, the discovery module 108 sends either a connection request (for example, to find a suitable printer) or a service request (print command to a selected MFD) to the network 104.

The network 104 transfers the connection or service request to the correct MFD. To this end, the network 104 includes processing and connection modules. The processing module 110 manages connectivity of various devices in the network 104. For example, the module receives connection requests from the discovery module 108 and processes this request to determine the correct MFD. In one embodiment, the processing module 110 extracts a telephone number from the request and looks up a corresponding IP addresses to determine the connection path to the desired MFD. The processing module also determines the IP address of the sending computing device 102 to setup a direct communication path between the computing device 102 and MFD 106. This module may be part of the computing device's enterprise network or part of a macro network, such as the Internet or a cellular network. In any network, the processing module 110 maintains a database or lookup table managing the telephone numbers and IP addresses associated with the MFDs and the computing devices 102 connected to the network 104.

The processing module 110 transfers IP address information and the telephone number to the connection module 112, which then attempts to connect the computing device 102 with the desired MFD 106. In one embodiment, the connection module 112 may be part of any suitable cellular network. This module utilizes the telephone number associated with the MFD 106 and its corresponding IP address to setup a data link between the MFD 106 and the computing device 102. Such a communication link may be a GPRS data connection, an EDGE data connection, or a HSDPA data connection. It will be understood that any other cellular data connection link may be setup between the computing device and the MFD without departing from the scope of the disclosure.

The connection module 112 may impart additional functionality to the MFD such as queuing, authenticating, prioritizing, or forwarding print jobs to MFDs with relatively shorter queue lengths MFD. Because the connection module 112 is part of a cellular network, it may utilize telecommunication functionalities such as call barring, call waiting, and call forwarding to provide these functionalities. For example, the connection module 112 may not setup a connection between the MFD 106 and the computing device 102, if the computing device's IP address is part of a screening or barring list. Similarly, based on IP address of incoming request, the connection module 112 may change the priority level or queue position of pending requests.

In another embodiment, the connection module 112 may include an authentication system. This system requests the discovery module 108 to enter a password to connect with the MFD 106, and if the password is incorrect, the connection module may not complete the connection. To this end, the connection module may include a security module to compare submitted passwords with passwords associated with a requested MFD.

The cellular interface 114, present on each MFD, facilitates cellular connectivity. This interface may include a cellular port 116 and a cellular card 118. The cellular card includes a cellular identification code, such as a telephone number, that is assigned to the MFD. Further, the cellular card 118 may employ hardware, software, and firmware, imparting cellular functionality to MFD 106. Additionally, cellular card 118 can employ a cellular modem via which MFD 106 can be accessed. Such cellular components are known and they are not described in detail here. It is to be appreciated and understood that cellular components need not reside inside MFD 106. Some of the components that impart cellular functionality can be configured externally to MFD 106. The cellular interface 114 may also include a cellular antenna (not shown) to detect cellular signals and transmit information when required.

It will be understood that because the MFD is connected to a cellular interface it may be moved anywhere in the world. Moreover, configuring the MFD is facilitated by the fact that the telephone number associated with the MFD may remain the same even if the MFD is transferred from one city to another. Changes are only required to the translation database in the processing module. In some embodiments, the processing module in connection with the connection module updates the translation database automatically without any user or administrator interference.

As illustrated in FIG. 1, the MFD includes other modules to impart additional functionality. These modules include processor 120, scheduler 122, and servicing unit 124.

Processor 120 processes various instructions necessary to operate MFD 106 and communicate with other devices. The scheduler 122 maintains an order of job requests to be serviced by MFD 106 using any known job scheduling algorithm. Processor 120 along with the scheduler 122 provides input to a servicing unit 124, instructing it to perform a desired activity, such as printing or copying. Servicing unit 124 includes mechanisms that are arranged to selectively apply ink (e.g., liquid ink, toner, etc.) to a print media (e.g., paper, plastic, fabric, etc.), in accordance with print data within a print job. Those skilled in the art will recognize that there are many different types of servicing units available, and that for the purposes of the present discussion, servicing unit 124 can include any of those known types.

MFD 106 also includes computer-readable media such as an EEPROM and RAM. Further, computer-readable media 120 can include a hard drive, ROM, or an EEPROM. These media can store information such as configuration information, fonts, templates, printing data, and menu structure information. Computer-readable media may be a disk drive that provides additional storage for printing data, for example, or other information used by MFD 106.

The illustrated MFD can, and typically does include a module that provides a runtime environment in which applications or applets can run or execute. The runtime environment can facilitate the extensibility of MFD 106 by allowing various interfaces to be defined that, in turn, allow applications or applets to interact with MFD 106 in more manners that are robust.

The following sections will describe various exemplary situations and scenarios where embodiments of the system 100 may be implemented. It will be understood that these scenarios are merely exemplary and the system 100 may be used in various other applications without departing from the scope of the present disclosure.

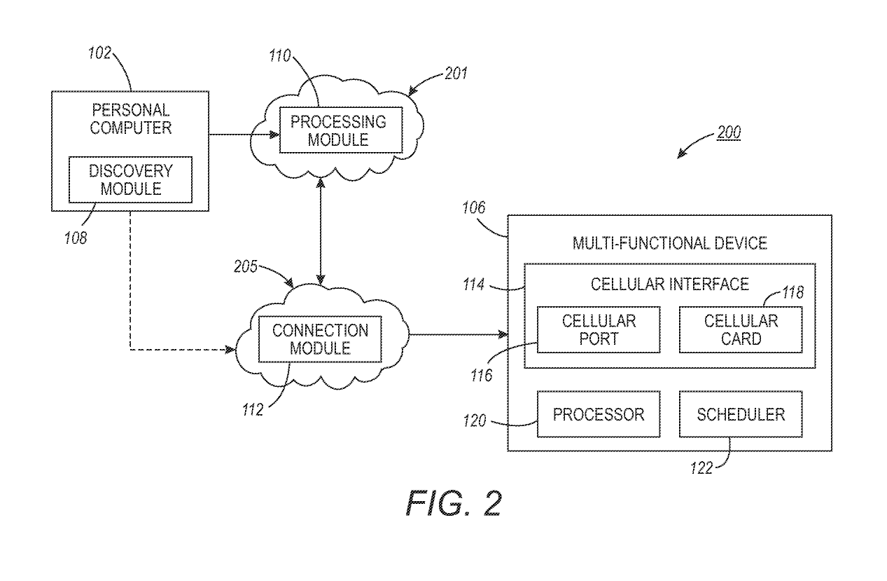

FIG. 2 illustrates an exemplary system 200 where the computing device 102 is a personal computer connected to an enterprise network, while the MFD is connected to a cellular network. Here, the processing module 110 may be part of the enterprise network, which interconnects multiple personal computers and other devices. The enterprise network may further include a server and a network interface that directly connects to a cellular network. The connection module may be part of the cellular network. For example, a cellular network operator may operate the connection module.

The personal computer 102 sends a connection request including an access code, such as a telephone number, to processing module 110, using discovery module 108. To validate the telephone number, processing module 110 compares this telephone number with the pre-populated list of telephone numbers corresponding to the MFDs stored in database 202. If the phone number matches with one of the stored telephone numbers, processing module 204 determines the IP address corresponding to the telephone number. Further, processing module 110 sends the IP address to connection module 112 to locate and set up a cellular data connection with the requested MFD, such as MFD 106, through cellular interface 114. After connection, computing device 102 can access MFD 106 and opt for imaging services, such as printing, scanning, or copying. In one embodiment, processing module 110 may directly facilitate communication between personal computer 102 and MFD 106, if the MFD includes the Ethernet interface as well.

In an alternative embodiment (not shown), personal computer 102 may be a standalone computing device in a cyber cafe, for example. Personal computer 102 sends a connection request including an access code, such as a telephone number to a cellular network operator via the Internet. The cellular network operator then provides functionalities of the processing module 110 and connection module 112. The cellular network operator processes the received telephone number to determine the IP address associated with the requested MFD. This process requires translating the telephone number into corresponding IP address using a database. Subsequently, the network provider sets up a cellular data connection between personal computer 102 and MFD 106, for example, through cellular interface 114.

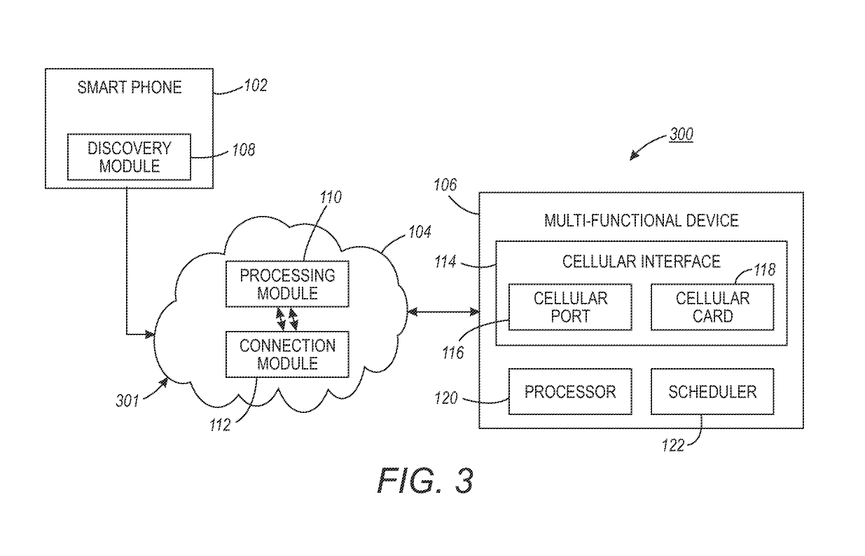

FIG. 3 illustrates an exemplary system 300 providing connectivity between computer device 102, which is a Smartphone 102, and one or more multi-function devices (MFDs) 106 in a cellular network 301. For description purposes, computer device 102 is referred to as Smartphone 102 with the description of this figure. A Smartphone is a high-end mobile phone that offers advanced computing ability and connectivity by combining the functions of a personal digital assistant (PDA) and a mobile phone, and serving mobile broadband access.

This arrangement enables cellular data connection, such as 3G connectivity, between the Smartphone 102 and the connection module 112. Here, processing module 110 and connection module 112 are part of cellular network 301, which may be managed by a cellular network operator. In this embodiment, the cellular network operator assigns IP addresses to both the MFDs and smart phones. The cellular network operator facilitates cellular data connection between the two devices using this assigned IP address.

Operation commences to identify a desired MFD and connect to it on the network. Smartphone 102 sends a connection request through discovery module 108 to connection module 112 through cellular base stations. The request involves sending an access code such as a telephone number, corresponding to the desired MFD. To process the connection request, connection module 112 forwards it to processing module 110, which compares this telephone number with the pre-populated list of telephone numbers corresponding to the MFDs stored in database 202 to validate the telephone number. In case the phone number matches with one of the stored telephone numbers, processing module 204 determines the IP address corresponding to the telephone number. After processing the connection request, processing module 110 sends the IP address to connection module to locate and set up a cellular data connection with the requested MFD, such as MFD 106. After connection, computing device 102 can access MFD 106 and opt for imaging services, such as printing, scanning, or copying.

It can be understood that connection modules such as cellular network operators can allow a user to directly access MFD. For example, a user carries a cell phone to one location and a printer to one location. To connect to the printer placed at home, the user may not require any network administrator. The user can simply dial a telephone number assigned to the printer for connection. Service providers may offer a 3G interface on the printer for setting up a cellular data connection. Moreover, several manufacturers of MFDs, either on their own or in coordination with other known cellular network service providers, offer cellular functionality to the MFD.

In the illustrated embodiments, processing module 110 may redirect the connection request to multiple processing modules if the requested MFD is not identified. One of these additional modules having knowledge of the IP address sent by processing module 110 may discover the requested MFD.

Additionally, in the illustrated embodiments, known GSM technology may be implemented by incorporating a Subscriber Identity module (SIM card) in cellular card 128. Consider an example of a MFD that can be shared by two different users having different SIM cards. Each user can insert his SIM card into the cellular card slot for user authentication. Subsequently, connection module such as a cellular network operator gives access to the authenticated user for forwarding any imaging request. Utilization of personal SIM cards makes billing an easy task. For example, in a printing shop, such as Kinko's, users can simply insert their own SIM cards for printing. The cellular operator may then add printing costs directly in the users' cellular bills.

Moreover, movement of the MFD may also require a new SIM card for obtaining authorized access to the MFD. Based on the new location, a new SIM card may be inserted in the cellular port 126.

Alternatively, MFD 106 may operate in a CDMA technology cellular network. Here, the cellular card 128 may be an integrated chip. Once the connection request is processed, and the user is granted access, imaging services may be provided by MFD 106.

Another application of a cellular connected MFD is in location-based services. When an MFD moves from one location to another, the cellular network may determine the MFDs new location. Based on this location, multiple services may be incorporated. For example, certain language based features or settings of the MFD can be automatically modified when the printer moves to another city or country. Similarly, location-based advertising may be incorporated in printed documents. For example, if a user sends a print command from an online web portal, the web portal may embed location-based advertising in the printed document, based on the MFD's location.

Connection modules, not just limited to cellular network operators, offer several known call handling features. The equivalent features may be implemented for making connection module 112 effectively functional in a network, particularly a cellular network. For example, concept of call waiting can be implemented to handle prioritized printing requests. To optimize available resources, call forwarding may be used in forwarding printing requests to other printers. Moreover, call-blocking feature can be put into service to eliminate unauthorized access. Because of these additional features, a user working on computing device 102 may not need to develop an exhaustive understanding of the firewall settings configured to access printers, such as MFD 106. In addition, portable printers need not be reconfigured as the call-blocking functionality manages access.

It will be appreciated that several of the above-disclosed and other features and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

1. A system for providing connectivity with a computing device, the system comprising:
a multi-function device having the functionalities of printing, scanning, and copying;
a cellular interface, connected to the multiple multi-function device, for assigning a cellular identification code to the multi-function device;
a discovery module, deployed at the computing device, configured to generate a connection request to access the multi-function device, the request including an access code;
a processing module for comparing the access code with the cellular identification code, and determining an address associated with the multi-function device using the access code;
a connection module for providing a cellular data connectivity between the computing device and the multi-function device based on the determined address.

2. The system of claim 1, wherein the cellular identification code comprises a telephone number.

3. The system of claim 1, wherein the access code comprises a telephone number.

4. The system of claim 1 further includes a database having a list of the cellular identification codes and corresponding address.

5. The system of claim 1, wherein the connection module provides connection between the computing device and the multi-function device based on access rights associated with the computing device.

6. The system of claim 1, wherein the cellular interface includes a cellular port and a cellular card.

7. The system of claim 6, wherein the cellular card comprises a Subscriber Identity module (SIM) card.

8. The system of claim 1, wherein the address comprises an Internet Protocol (IP) address.

9. (canceled)

10. A device configured to communicate on a cellular network, the device comprising:
a multi-function device having the functionalities of printing, scanning, and copying;
a cellular interface associating a cellular identification code with the multi-function device; and
a connection module, coupled to the multi-function device, wherein the connection module is configured to:
receive a connection request including an access code;
compare the access code with the cellular identification code;
determine an address associated with the multi-function device using the access code; and
provide a cellular data connection with the multi-function device.

11. (canceled)

12. The system of claim 10, wherein the address comprises an Internet Protocol (IP) address.

13. The device of claim 10, wherein the multi-function device includes an Ethernet interface.

14. The system of claim 10, wherein the cellular identification code comprises a phone number.

15. The system of claim 10, wherein the access code comprises a phone number.

16. A method for connecting a computing device to a device, the method comprising:
providing a multi-function device having the functionalities of printing, scanning, and copying;
receiving a connection request, including an access code;
validating the access code, including comparing the access code with a cellular identification code;
determining an address associated with the multi-function device upon a determination that the access code is valid; and
setting up a cellular data connection between the computing device and the multi-function device.

17. The method of claim 16, wherein the access code comprises a phone number.

18. The method of claim 16, wherein comparison step involves comparing the access code with one or more cellular identification codes associated with one or more multi-function devices.

19. The method of claim 16, wherein determination of the address associated with the multi-function device takes place when the access code matches with the cellular identification code.

20. The method of claim 16, wherein the setting up step includes verifying access rights associated with the computing device.
